(19) United States
(12) Patent Application Publication
(10) Pub. No.: US 2011/0280995 A1
(43) Pub. Date: Nov. 17, 2011

(54) BLACK PEPPER SUBSTITUTE

(76) Inventor: DENNIS J. DOUGHERTY, St. Augustine, FL (US)

(21) Appl. No.: 13/191,353

(22) Filed: Jul. 26, 2011

Related U.S. Application Data
(63) Continuation-in-part of application No. 12/204,001, filed on Sep. 4, 2008.

(51) Int. Cl. A23L 1/22

(52) U.S. Cl. 426/93; 426/96; 426/303

(57) ABSTRACT

The black pepper substitute is a black pepper seasoning free from the peppercorn shell found in typical black pepper. The black pepper substitute includes a starch substrate coated with black pepper oleoresin. The coated starch substrate is dried, coated with carrot fiber, and ground or crushed. In order to make the black pepper substitute, a starch product is boiled. to produce a porous starch substrate. The starch product may be wheat-based, or may be brown rice. The substrate forms a digestible vehicle or carrier for antioxidants, such as piperine, contained in the black pepper oleoresin. The substitute provides consistent levels of antioxidants per serving without requiring fumigation to remove contaminants, and provides the natural aroma and flavor of black pepper.

### CROSS-REFERENCE TO RELATED APPLICATION

This application is a continuation-in-part of U.S. patent application Ser. No. 12/204,001, filed on Sep. 4, 2008.

### BACKGROUND OF THE INVENTION

1. Field of the Invention

The present invention relates to food spices and seasonings, and particularly to a black pepper substitute that is free from peppercorn shells.

2. Description of the Related Art

Black pepper (Piper nigrum) is a flowering vine in the family Piperaceae, cultivated for its fruit, which is usually dried and used as a spice and seasoning. The fruit, known as a peppercorn when dried, is ground to produce black pepper. Piperine is the alkaloid responsible for the pungency of black pepper and long pepper, along with chavicine (an isomer of piperine). Piperine has been used in some forms of traditional medicine, and also has been found to act as a thermogenic compound. Piperine enhances the thermogenesis of lipids and accelerates energy metabolism in the body. Piperine has also been found to increase serotonin and beta-endorphin production in the brain. Extracts from black pepper have been found to have antioxidant properties and. anti-carcinogenic effects.

Despite the benefits of the piperine found in black pepper, peppercorns contain small amounts of safrole, a mildly carcinogenic compound. Peppercorns are often eliminated from the diet of patients having abdominal surgery and ulcers because of the irritating effect upon the intestines. Further, the piperine found in conventional black pepper is often contained within the ground shells of the peppercorns, which are largely indigestible. It would obviously be desirable to produce a source of the beneficial piperine, without the harmful effects of the peppercorns, which is readily bioavailable and easily digestible.

Thus, a black pepper substitute solving the aforementioned problems is desired.

### SUMMARY OF THE INVENTION

The black pepper substitute is a black pepper seasoning free from the peppercorn shell found in typical black pepper. Starch is used as a substitute for the peppercorn shell. The black pepper substitute includes an inner starch base or substrate, which may be formed from wheat starch, starch derived from brown rice, or the which is coated with oleoresin of Piper nigrum (black pepper), dried, coated with carrot fiber. When the starch substrate is wheat-based, olive oil may be added to keep the starch substrate from sticking together during mixing.

In order to make the black pepper substitute, hardened starch is boiled to produce a porous starch substrate. The porous starch substrate is then coated with black pepper oleoresin by mixing in a bowl. The coated substrate is dried to form an intermediate product. The intermediate product is coated with carrot fiber and ground to form a solid black pepper substitute. The carrot fiber serves as a flow agent to prevent the grinder from becoming clogged.

The dried and crushed black pepper substitute may be used in lieu of conventional black pepper. The starch base or substrate is more digestible than peppercorn husks or shells, and serves as a better vehicle or carder for piperine, which is an antioxidant thought to have health benefits. The black pepper substitute provides a consistent amount of piperine per serving, and does not require fumigation for the removal of contaminants, as does conventional black pepper.

These and other features of the present invention will become readily apparent upon further review of the following specification.

### DETAILED DESCRIPTION OF THE PREFERRED EMBODIMENTS

The black pepper substitute is a black pepper seasoning that is free from the peppercorn shell found in typical black pepper. Starch is used as a substitute for the peppercorn shell. The black pepper substitute includes a starch base or substrate, which is coated with black pepper oleoresin (oleoresin of Piper nigrum) by mixing in a bowl. The coated substrate is dried, coated with carrot fiber, and ground or crushed. The starch may be in the firm of hardened wheat, dried wheatpaste, hardened wheatpaste, wheat starch, starch derived from brown rice or the like. Preferably, the hardened starch is provided in dry form in strands, similar in shape and consistency to dried spaghetti. Black pepper oleoresin is a commercially available product formed by solvent extraction from the dried berries or peppercorns of the pepper plant, and is often used as a colorant of flavoring agent in the food industry. The oleoresin differs from the essential oil by retaining the spice flavor, whereas the essential oil only retains the aroma.

In order to make the black pepper substitute, the hardened starch is first boiled to produce a porous starch substrate. The boiling process is similar to the boiling of spaghetti or other pasta, producing tender, porous strands. The boiled product is drained, leaving the tender, porous starch substrate in strand form.

The porous starch substrate is then coated. When wheat-based starch is utilized, the starch substrate is coated with olive oil, preferably by mixing together in a bowl or the like, allowing for full coating and at least partial absorption of the olive oil within the porous starch substrate. The porous starch substrate is also coated with black pepper oleoresin, and by mixing in a bowl of the like. The black pepper oleoresin is provided as a natural flavoring, giving the second intermediate product the flavor of black pepper, and also provides a source of natural antioxidants. When using brown rice as the source of the starch substrate, no olive oil is necessary and the porous starch substrate is only coated with the black pepper oleoresin. The olive oil is used primarily to keep wheat-based starch substrates loose and prevent them from sticking together during mixing (much like spaghetti and lasagna noodles stick together after boiling), ensuring that each starch shell is coated with the black pepper oleoresin.

The coated substrate is then dried. The drying may occur on sheet pans in a conventional oven or the like, forming an intermediate product. The drying preferably involves application of heat, with the heat being sufficient to remove any remaining moisture, but being low enough to prevent any significant loss of piperine or other volatile content from the black pepper oleoresin.

The intermediate product is then coated with carrot fiber. The coated intermediate product is preferably sealed in a closed container for a sufficient time to allow individual strands or segments of the coated, dried second intermediate product to adhere to one another in the closed container. The carrot fiber primarily serves as a flow agent to prevent gumming in a grinder when the solid product is later ground.

The solid black pepper substitute is ground to produce a granulated black pepper substitute. Preferably, the grinding does not take place in the presence of additional heat. The solid black pepper substitute may be ground using any suitable type of grinder, such as a conventional coffee grinder or the like. The granulated black pepper substitute is ground so that it has the size and consistency of conventional black pepper, allowing the granulated black pepper substitute to be dispensed from a conventional black pepper shaker or the like. It should be understood that the granulated black pepper substitute may be packaged and distributed in a manner similar to conventional black pepper.

It is to be understood that the present invention is not limited to the embodiments described above, but encompasses any and all embodiments within the scope of the following claims.

1. A black pepper substitute, comprising:
a starch substrate; and
a coating of black pepper oleoresin formed on the starch substrate, the coated starch substrate being dried and ground.

2. The black pepper substitute according to claim 1, further comprising carrot fiber coated on the starch substrate.

3. The black pepper substitute according to claim 1, wherein said starch substrate comprises hardened wheat.

4. The black pepper substitute according to claim 1, further comprising a coating of olive oil formed on the starch substrate.

5. The black pepper substitute according to claim 4, wherein said starch substrate comprises brown rice.

6. A method of making a black pepper substitute, comprising the steps of:
boiling a starch substrate to produce a porous starch substrate;
coating the porous starch substrate with black pepper oleoresin;
drying the coated starch substrate to form an intermediate product;
coating the intermediate product with carrot fiber; and
grinding the coated intermediate product to form the black pepper substitute.

7. The method of making a black pepper substitute as recited in claim 6, wherein said drying step comprises drying the coated starch substrate on sheet pans in an oven.

8. The method of making a black pepper substitute as recited in claim 6, where said step of coating the intermediate product is carried out in a closed container.

9. The method of making a black pepper substitute as recited in claim 8, wherein said step of drying the coated starch substitute comprises heating the coated starch substitute, wherein the heat is sufficient to eliminate moisture without loss of volatile components of the oleoresin.

10. The method of making a black pepper substitute according to claim 6, wherein said starch substrate comprises a wheat product.

11. The method of making a black pepper substitute according to claim 10, further comprising the step of coating the porous starch substrate with olive oil.

12. The method of making a black pepper substitute according to claim 6, wherein said starch substrate comprises brown rice.
